(19) United States
(12) Patent Application Publication
(10) Pub. No.: US 2024/0077884 A1
(43) Pub. Date: Mar. 7, 2024

(54) SYSTEM AND METHOD USING A SYSTEM

(71) Applicant: SICK AG, Waldkirch (DE)

(72) Inventors: Boris SCHMITT, Waldkirch (DE); Ralph RAPP, Waldkirch (DE)

(21) Appl. No.: 18/243,066

(22) Filed: Sep. 6, 2023

(30) Foreign Application Priority Data
Sep. 6, 2022 (DE) 102022122508.9

(51) Int. Cl. G05D 1/02

(52) U.S. Cl. CPC G05D 1/0278; G05D 1/027; G05D 2201/0201; G05D 2201/0202

(57) ABSTRACT

A method using a system and a system having at least one autonomous vehicle, with the autonomous vehicle having at least one drive, at least one brake, and at least one steering, with the vehicle having a navigation system, with the navigation system having a first radio receiver for a global navigation satellite system and a second radio receiver for a global navigation satellite system, with the first radio receiver and the second radio receiver being arranged at a predefined spacing on the vehicle, with the navigation system having a control and evaluation unit to which the first radio receiver and the second radio receiver are connected, with the control and evaluation unit having two independent processor units, with the control and evaluation unit being configured to evaluate the position data of the first radio receiver and the position data of the second radio receiver using both processor units and to compare them with one another, and with the control and evaluation unit being configured to generate checked position data on a valid agreement of the position data.

The present invention relates to a system having at least one autonomous vehicle and to a method using a system.

Autonomous driving machines in the outdoor sector that work e.g. in an agricultural environment or on construction sites have to be functionally safe to prevent hazardous collisions. It must furthermore be ensured that the machines do not leave the boundaries of the working zone assigned to them. An agricultural robot that works on an agricultural area should not, for example, make its way onto public paths or roads without supervision. In the construction site sector, machines such as road rollers may not leave the boundaries of the construction site and thereby e.g. make their way into moving traffic.

In accordance with the prior art, localization is based on triangulation or on the signal time of flight between a plurality of geostationary satellites in space and radio receivers on the ground. Positions can thus, for example, be localized with an accuracy of approximately 2.5 m.

The localization is carried out as a rule only via one radio receiver. The information can thus not be verified or plausibilized and is therefore not usable for a functional safe positioning.

DE 10 2020 208 304 A1 discloses a method that is carried out by a processor system for a work machine on a work site, with the method comprising the following: automatically identifying a set of local units that correspond to the work site based on signals that are detected by the set of local units, with each of the local units being configured to transmit correction data for the correction of position data derived from a satellite navigation signal; selecting one or more local units from the set of local units; receiving the satellite navigation signal; generating the position data that indicate a geographical position from the received satellite navigation signal of the work machine at the work site; receiving the correction data from the one or more local units; generating corrected position data by applying the correction data to the position data; and controlling the work machine based on the corrected position data.

It is an object of the invention to provide a system that is able to functionally safely localize a machine in the outdoor area and to forward the information to a vehicle control and/or to a superior control such that the position of the machine can be determined functionally safely.

The object is satisfied by a system having at least one autonomous vehicle, wherein the autonomous vehicle has at least one drive, at least one brake, and at least one steering, wherein the vehicle has a navigation system, wherein the navigation system has a first radio receiver and a second radio receiver, wherein the first radio receiver and the second radio receiver are arranged at a predefined spacing on the vehicle, wherein the navigation system has a control and evaluation unit to which the first radio receiver and the second radio receiver are connected, with the control and evaluation unit having two independent processor units, with the control and evaluation unit being configured to evaluate the position data of the first radio receiver and to evaluate the position data of the second radio receiver using both processor units and to compare them with one another, and with the control and evaluation unit being configured to generate checked position data on a valid agreement of the position data.

The object is further satisfied by a method using a system having at least one autonomous vehicle, wherein the autonomous vehicle has at least one drive, at least one brake, and at least one steering, wherein the vehicle has a navigation system, wherein the navigation system has a first radio receiver and a second radio receiver, wherein the first radio receiver and the second radio receiver are arranged at a predefined spacing on the vehicle, wherein the navigation system has a control and evaluation unit to which the first radio receiver and the second radio receiver are connected, with the control and evaluation unit having two independent processor units, with the control and evaluation unit evaluating the position data of the first radio receiver and the position data of the second radio receiver using both processor units and comparing them with one another, and with the control and evaluation unit generating checked position data on a valid agreement of the position data.

In accordance with the invention, the position of the autonomous vehicle can be monitored via a functionally safe localization and the actuator system of the autonomous vehicle, that is the drive, the brake, and/or the steering, can be influenced or controlled by the control and evaluation unit or by a machine controller such that a leaving of the defined working zone is prevented.

Functional safety is regulated in the standard IEC 61508 or IEC 62061. Functional safety designates that part of the safety of a system that depends on the correct function of the safety related system and on other risk reducing measures.

The standard series IEC 61508 “Functional Safety of Electrical/Electronic/Programmable Electronic Safety-related Systems” accordingly requires the use of various methods to cope with errors
avoidance of systematic errors in development, e.g. specification and implementation errors;
monitoring in ongoing operation to recognize random errors; and
safe dealing with recognized errors and transition into a state previously defined as safe.

IEC 61508 is a series of international standards for the development of electrical, electronic, and programmable electronic (E/E/PE) systems that perform a safety function

One element is the determination of the safety integrity level (SIL; there are SIL 1 to SIL4). The safety integrity level is a term from the field of functional safety and is also called a safety level in the international standard in accordance with IEC 61508. It serves the evaluation of electrical/electronic/programmable electronic (E/E/PE) systems with respect to the reliably of safety functions. The safety related design principles that have to be observed so that the risk of malfunction can be minimized result from the intended level.

Two-channel system in which each channel can per se trigger the safety function on its own, can reach a higher SIL with less technical effort than those that only have one channel. A channel here is the information flow through a safety chain, starting from the demand of the safety function and ending with the actuator or control element that determines the safe state of the autonomous vehicle.

The standard IEC 62061 lays down requirements and provides recommendations for the preparation, integration, and validation of electrical, electronic, and programmable electronic safety-related control systems for machines. The standard is applicable to control systems that are used either singly or in combination to carry out safety-related control functions on machines.

In accordance with the invention, two processer units or processing units are used that mutually exchange data (results, intermediate results, test data, i.a.). A redundant system is formed by the two processor units. A comparison of the data is carried out by software in each processor unit; disparity results in an error message that can be used, for example, to switch off the drive, to initiate a steering procedure, and/or to initiate a braking procedure.

The two processor units can be of identical design. However, the processor units can also be respectively different. A diverse, redundant system is thereby formed. Systematic errors that may be present in a processor unit are then uncovered with a very high likelihood by the parallel second processor unit.

The processor units are connected to one another by means of a communication interface. The results of the first processor unit can thereby be transmitted to the second processor unit and conversely can be transmitted from the second processor unit to the first processor unit. One processor unit respectively checks the results of the other processor unit.

The processor units can, for example, be formed by microcontrollers, microprocessors, digital signal processors, and similar.

The system thus forms a safety system that has an at least two-channel design. Whereas single channel systems as a rule respond to errors with a failure, two-channel or multichannel systems can check one another and can recognize possible errors.

The control and evaluation unit can thus also be formed by a safety controller.

A diagnostic coverage is preferably provided. The processor units are tested cyclically regularly so a failure or a defect can be recognized. The diagnostic coverage (DC) indicates the likelihood with which the errors will be revealed by a test. The regular tests of the system have the result that it is determined whether the system is still functioning. The diagnostic coverage here depends on the quality of the test. The processor units, for example, each carry out self tests to reveal errors. Provision can furthermore also be made that the processor units test each other, whereby errors can be even more effectively avoided, whereby a high diagnostic coverage is reached.

Radio receivers are satellite navigation system receivers that are configured to receive signals from a set of satellite transmitters. A radio receiver is a receiver for a global navigation satellite system (GNSS system) that receives signals from one or more radio satellite transmitters.

The satellite transmitters are part of a satellite navigation system and generate corresponding satellite navigation signals that are detected by the satellite navigation signal detection logic. The satellite navigation system can comprise a plurality of different types. In an example, satellite transmitters form part of a global navigation satellite system (GNSS). Examples for such systems are inter alia GPS, GLONASS, BEIDOU, GALILEO, QZSS, IRNSS, and SBAS that use satellites in space to localize the position (e.g. three-dimensional coordinates) of radio receivers or their antennas on or above the earth. Both pseudodistance radio measurements and integrated carrier phase radio measurements are typically available within a civil radio receiver for every carrier signal of every radio satellite that is tracked. The pseudo distance measurement detects the apparent period of time the respective code requires to reach the receiver from the satellite. The period of time is the same as the time at which the signal arrives at the receiver according to the receiver clock less the time at which the signal left the satellite according to the satellite clock.

In accordance with the invention, two sets of GPS coordinates are detected and verified with respect to one another via the use of two radio receivers having a defined spacing. The accuracy of the radio positioning here depends on a plurality of factors, with the greatest difference originating from the troposphere and ionosphere. Both the pressure and the humidity in the troposphere and the degree of ionization of the ionosphere have a direct influence on the time of flight of the signals between satellites and the radio receiver. These differences have the same effect on both antennas or on both radio receivers as long as they are only a few meters apart. The detected coordinates can thus be validated by the known spacing of the two antennas from one another. The spacing amounts, for example, to at most 5 m or less. Preferred spacings amounts to approximately 1 m. The spacing should here preferably be greater than approximately 30 cm. However, smaller spacings can also be provided with very small vehicles.

As soon as the determined positions of the two radio antennas or radio receivers with respect to one another differ from one another by a predetermined amount, the vehicle or the machine is set into a defined safe state by the control and evaluation unit or the machine controller.

The first radio receiver and the second radio receiver both forward the detected and initially uncorrected coordinates to a safe comparator that is formed by the processor units of the control and evaluation unit. The comparator checks whether the distance δ between the coordinates agrees with the actual installation distance of the two radio receivers except for a provided tolerance. The detected position value is thus validated and can be used as the basis for an accurate position detection.

The invention makes possible an accurate and safe positioning of the mobile vehicle or the mobile machine in an outdoor area, for example an agricultural area or a construction site. It is thus possible to restrict the autonomous vehicle in a zone while ensuring that the autonomous vehicle does not leave the deployment zone. It can, for example, be ensured that an autonomous tractor works in the field and does not drive onto a highway or interstate. The direction of travel of the vehicle can also be reliably determined by the exact localization of the two antennas of the radio receivers as can its inclination since the position detection of each radio receiver takes place in space and not only in a flat plane. The direction of the vehicle can be determined from the position of the two radio receivers with respect to one another in space.

In accordance with a further development of the invention, the navigation system has a first real time kinematic receiver, with the first real time kinematic receiver being connected to the control and evaluation unit, with the control and evaluation unit being configured to evaluate the position data of the first real time kinematic receiver and to correct the position data of the first radio receiver and/or the position data of the second radio receiver.

The position data of the first real time kinematic receiver are evaluated and are combined with the position data of the first radio receiver and/or the position data of the second radio receiver to correct the position data of the first radio receiver and/or the position data of the second radio receiver.

The real time kinematic receiver includes a real time kinematic component that is configured to improve the accuracy of position data that are derived from the radio signal from the radio receiver. A real time kinematic component uses measurements of the phase of the carrier wave of the signal, in addition to the information content of the signal, to provide real time corrections that can result in an accuracy of centimeters of the position determination.

To eliminate or reduce systematic errors, differential operations are used in radio applications, for example. Differential radio operations include one or more reference receivers that are located at known locations, also called base stations, together with a communication connection between the mobile real time kinematic receiver of the vehicle and the reference receiver. The reference receivers generate correction data that are associated with some or all of the above-named errors and the correction data are transmitted to the real time kinematic receiver via the communication connection. The mobile real time kinematic receiver then applies the correction data to its own carrier phase measurements or position estimates and thereby receives a more accurate calculated position. For example, local stationary real time kinematic base stations are provided that each have a wireless communication device and a reference receiver.

On a fluctuation of the GPS coordinates such that the distance between the antennas of the radio receivers could be lost in noise, the coordinates of every radio receiver are corrected using real time kinematic data of the real time kinematic receiver prior to the validation. To avoid a common cause failure, the correction values are used by two different real time kinematic ground stations. The correction information should here preferably originate within a distance of a maximum of 30 km in which as a rule in Europe a plurality of real time kinematic base stations/correction stations can be found. A mobile correction station can optionally also be set up at the deployment site.

In accordance with a further development of the invention, the navigation system has a second real time kinematic receiver, with the second real time kinematic receiver being connected to the control and evaluation unit, with the control and evaluation unit being configured to evaluate the position data of the second real time kinematic receiver and to correct the position data of the first radio receiver and/or the position data of the second radio receiver.

The position data of the second real time kinematic receiver are evaluated and are combined with the position data of the first radio receiver and/or the position data of the second radio receiver to correct the position data of the first radio receiver and/or the position data of the second radio receiver.

If a safety related positioning accuracy of, for example, 2.5 m is not sufficient, the coordinate sets of the radio receivers are corrected by means of the two real time kinematic receivers. A second real time kinematic ground station is also provided for this purpose. The safety related accuracy directly depends on the achievable accuracy of the second correction means, that is of the second real time kinematic receiver.

In accordance with a further development of the invention, the navigation system has at least one three axis inclinometer.

Since the radio receivers are attached at a defined spacing, for example on each side of a cabin of an autonomous vehicle or of an autonomous machine, a possible tilt of the autonomous vehicle can thus also be detected. The position can be even more accurately validated using the tilt information of the three axis inclinometer. The orientation of the autonomous vehicle is space can in particular be determined more precisely.

In accordance with a further development of the invention, the navigation system has at least one odometry sensor.

The positioning data are additionally validated in accordance with the further development by odometric data of the odometry sensor and thus the physical properties, for example of the speed, of the acceleration, or of the driving kinematics of the vehicle are additionally validated. A coordinate jump could thereby be recognized, for example, and could be used for a further validation since the autonomous vehicle only permits certain changes within a certain time period.

In accordance with a further development of the invention, the system has at least one first autonomous vehicle and at least one second autonomous vehicle, with the system having a coordination control, with the coordination control being configured to receive the checked position data of the first autonomous vehicle and to receive the checked position data of the second autonomous vehicle and being configured to calculate a predefined formation of the autonomous vehicles and to transmit calculated trajectory data to the first autonomous vehicle and to the second autonomous vehicle.

The use of the position of the first autonomous vehicle relative to the position of an at least second autonomous vehicle is an advantage. A possible collision between the first and second vehicles can thus be recognized in the coordination control or in a superior control and can be prevented by corresponding measures, for example a signal to the machine having the collision course, a change of the speed, and/or a change of the steering angle. This application has an advantage with groups of machines or in work processes in which a plurality of machines participate such as on a large construction site or in an agricultural environment in a harvesting process.

The invention will also be explained in the following with respect to further advantages and features with reference to the enclosed drawing and embodiments. The Figures of the drawing show in:

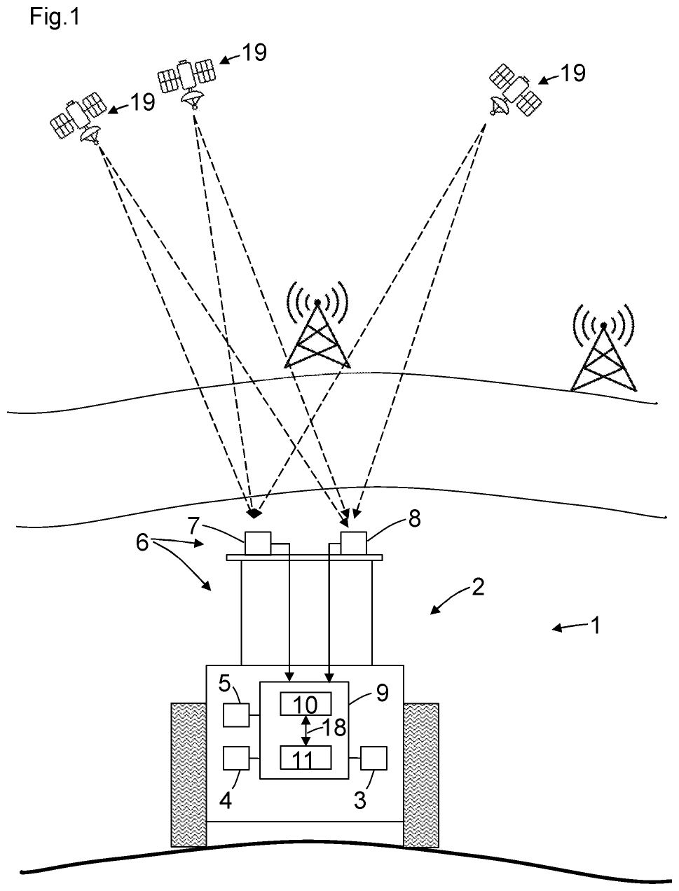

FIG. 1 a system with at least one autonomous vehicle;

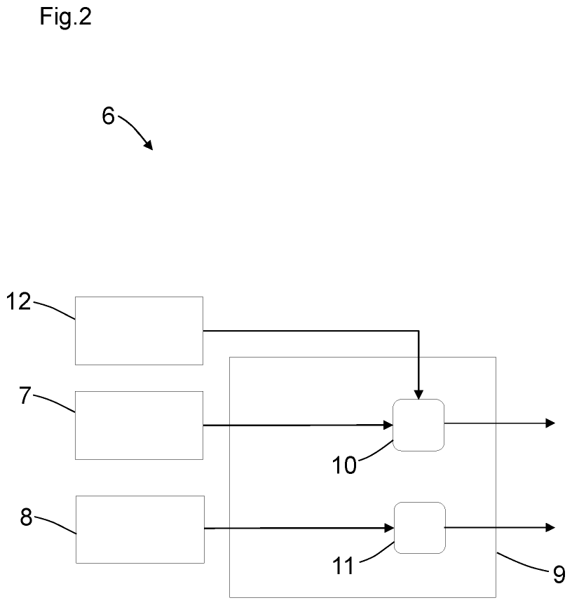

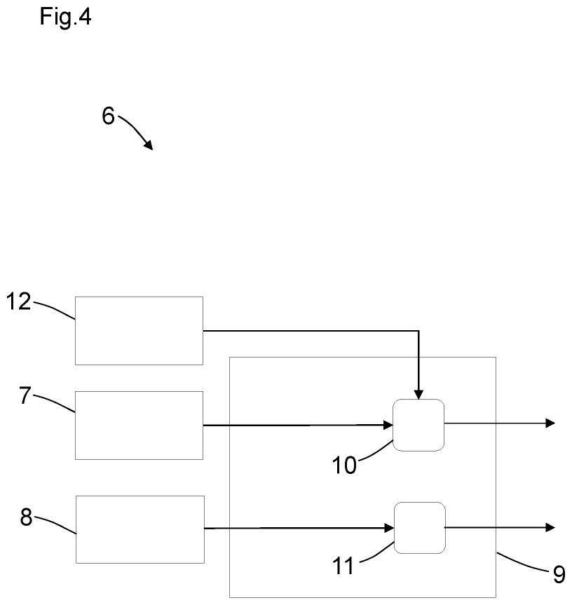

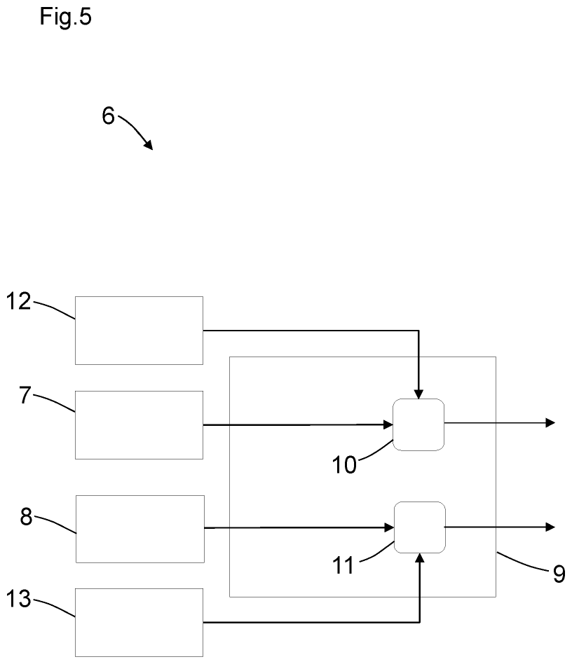

FIG. 2 to FIG. 7 respectively a navigation system; and

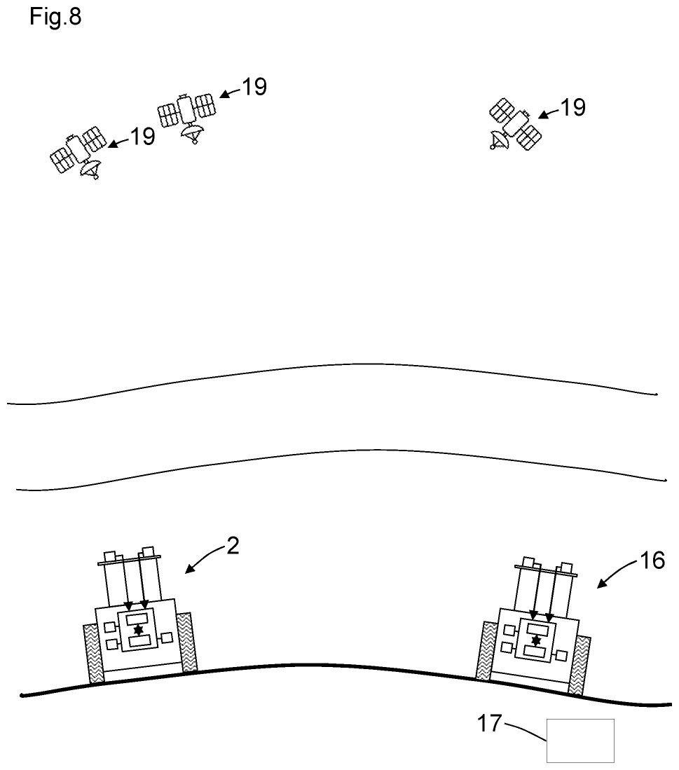

FIG. 8 a system 1 having at least one first autonomous vehicle 2 and at least one second autonomous vehicle 16.

In the following Figures, identical parts are provided with identical reference numerals.

FIG. 1 shows a system 1 having at least one autonomous vehicle 2, wherein the autonomous vehicle 2 has at least one drive 3, at least one brake 4, and at least one steering 5, wherein the vehicle 2 has a navigation system 6, wherein the navigation system 6 has a first radio receiver 7 and a second radio receiver 8, wherein the first radio receiver 7 and the second radio receiver 8 are arranged at a predefined spacing on the vehicle 2, wherein the navigation system 6 has a control and evaluation unit 9 to which the first radio receiver 7 and the second radio receiver 8 are connected, with the control and evaluation unit 9 having two independent processor units 10, 11, with the control and evaluation unit 9 being configured to evaluate the position data of the first radio receiver 7 and the position data of the second radio receiver 8 using both processor units 10, 11 and to compare them with one another, and with the control and evaluation unit 9 being configured to generate checked position data on a valid agreement of the position data.

In accordance with the system 1 in FIG. 1, the position of the autonomous vehicle 2 can be monitored via a functionally safe localization and the actuator system of the autonomous vehicle 2, that is the drive 3, the brake, 4 and/or the steering 5, can be influenced or controlled by the control and evaluation 9 unit or by a machine controller such that a leaving of the defined working zone is prevented.

Two processor units 10, 11 or processing units are used that mutually exchange data, for example results, intermediate results, and/or test data. A redundant system is formed by the two processor units 10, 11. A comparison of the data is carried out by software in each processor unit 10, 11. A determined disparity results in an error message that can be used, for example, to switch off or to reduce a speed of the drive 3, to initiate a steering procedure, and/or to initiate a braking procedure.

The two processor units 10, 11 can be of identical design. However, the processor units 10, 11 can also be respectively different. A diverse, redundant system 1 is thereby formed. Systematic errors that may be present in a processor unit 10 or 11 are then uncovered with a very high likelihood by the parallel second processor unit 11 or 10.

The processor units 10 and 11 are connected to one another by means of at least one connection interface 18. The results of the first processor unit 10 can thereby be transmitted to the second processor unit 11 and conversely can be transmitted from the second processor unit 11 to the first processor unit 10. One processor unit 10, 11 respectively checks the results of the other processor unit 11, 10.

The processor units 10, 11 can, for example, be formed by microcontrollers, microprocessors, digital signal processors, and similar.

The system 1 thus forms a safety system that has an at least two-channel design.

The processor units 10, 11 are tested cyclically regularly so a failure or a defect can be recognized. The processor units 10, 11, for example, each carry out self tests to reveal errors. Provision can furthermore also be made that the processor units 10, 11 test each other, whereby errors can be even more effectively avoided, whereby a high diagnostic coverage is reached.

Radio 7, 8 receivers are satellite navigation system receivers that are configured to receive signals from a set of satellite transmitters 19. A radio receiver 7, 8 is a receiver for a global navigation satellite system (GNSS system) that receives signals from one or more radio satellite transmitters 19.

The satellite transmitters 19 are part of a satellite navigation system and generate corresponding satellite navigation signals that are detected by the satellite navigation signal detection logic.

In accordance with FIG. 1, two sets of GPS coordinates are detected and verified with respect to one another via the use of two radio receivers 7, 8 having a defined spacing. The spacing amounts, for example, to at most 5 m or less. Preferred spacings amount to 1 m.

As soon as the determined positions of the two radio antennas or radio receivers 7, 8 with respect to one another differ from one another by a predetermined amount, the vehicle 2 or the machine is set into a defined safe state by the control and evaluation unit 9 or the machine controller.

The first radio receiver 7 and the second radio receiver 8 both forward the detected and initially uncorrected coordinates to a safe comparator that is formed by the processor units of the control and evaluation unit 9. The comparator checks whether the distance δ between the coordinates agrees with the actual installation distance of the two radio receivers 7, 8 except for a provided tolerance. The detected position value is thus validated and can be used as the basis for an accurate position detection.

The system 1 makes possible an accurate and safe positioning of the mobile vehicle 2 or the mobile machine in an outdoor area, for example an agricultural area or a construction site. It is thus possible to restrict the autonomous vehicle 2 in a zone while ensuring that the autonomous vehicle 2 does not leave the deployment zone. It can, for example, be ensured that an autonomous tractor works in the field and does not drive onto a highway or interstate. The direction of travel of the vehicle 2 can also be reliably determined by the exact localization of the two antennas of the radio receivers 7, 8 as can its inclination since the position detection of each radio receiver takes place in space and not only in a flat plane. The direction of the vehicle 2 can be determined from the position of the two radio receivers 7, 8 with respect to one another in space.

The navigation system 6 in accordance with FIG. 2, for example, has a first real time kinematic receiver 12, with the first real time kinematic receiver 12 being connected to the control and evaluation unit 9, with the control and evaluation unit 9 being configured to evaluate the position data of the first real time kinematic receiver 12 and to correct the position data of the first radio receiver 7 and/or the position data of the second radio receiver 8.

The real time kinematic receiver 12 includes a real time kinematic component that is configured to improve the accuracy of position data that are derived from the radio signal from the radio receiver 7. A real time kinematic component uses measurements of the phase of the carrier wave of the signal, in addition to the information content of the signal, to provide real time corrections that can result in an accuracy of centimeters of the position determination.

On a fluctuation of the GPS coordinates such that the spacing between the antennas of the radio receivers 7, 8 could be lost in noise, the coordinates of every radio receiver 7, 8 are corrected using real time kinematic data of the real time kinematic receiver 12 prior to the validation. To avoid a common cause failure, the correction values are used by two different real time kinematic ground stations.

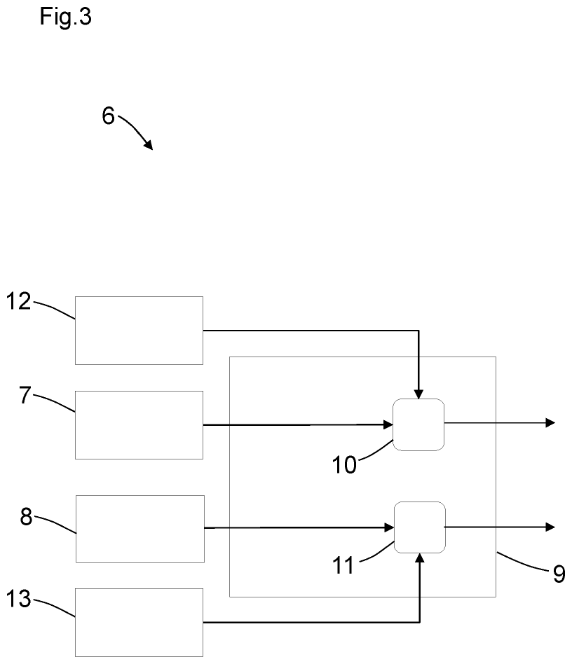

The navigation system 6 in accordance with FIG. 3, for example, has a second real time kinematic receiver 13, with the second real time kinematic receiver 13 being connected to the control and evaluation unit 9, with the control and evaluation unit 9 being configured to evaluate the position data of the second real time kinematic receiver 13 and to correct the position data of the first radio receiver 7 and/or the position data of the second radio receiver 8.

If a safety related positioning accuracy of, for example, 2.5 m is not sufficient, the coordinate sets of the radio receivers 7, 8 are corrected by means of the two real time kinematic receivers 12, 13. A second real time kinematic ground station is also provided for this purpose. The safety related accuracy directly depends on the achievable accuracy of the second correction means that is of the second real time kinematic receiver 13

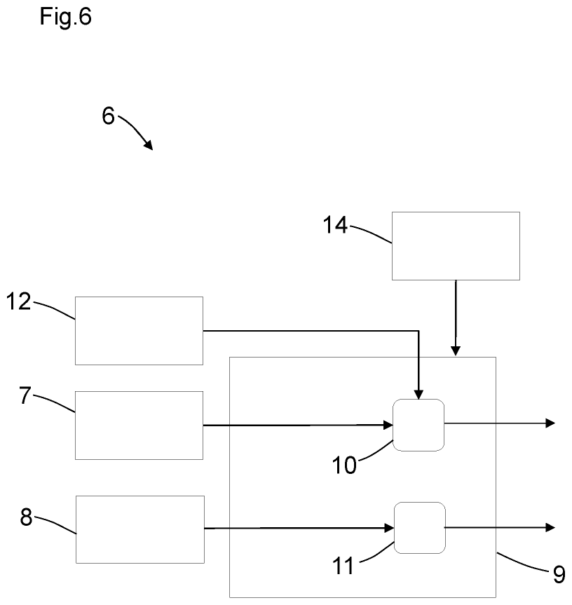

The navigation system 6 in accordance with FIG. 6, for example, has a three axis inclinometer 14.

Since the radio receivers 7 and 8 are attached at a defined spacing, for example on each side of a cabin of an autonomous vehicle 2 or of an autonomous machine, a possible tilt of the autonomous vehicle 2 can thus also be detected. The position can be even more accurately validated using the tilt information of the three axis inclinometer 14. The orientation of the autonomous vehicle 2 in space can in particular be determined more precisely.

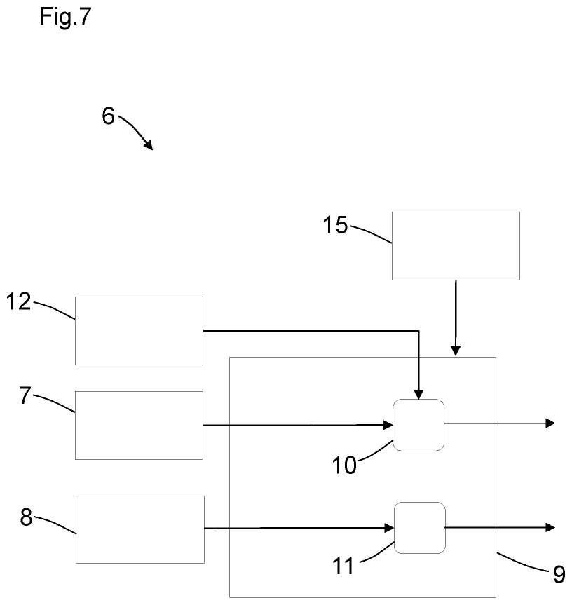

The navigation system 6 in accordance with FIG. 7, for example, has at least one odometry sensor 15.

The positioning data are additionally validated in accordance with the further development by odometric data of the odometry sensor 15 and thus the physical properties, for example of the speed, of the acceleration, or of the driving kinematics of the vehicle 2 are additionally validated. A coordinate jump could thereby be recognized, for example, and could be used for a further validation since the autonomous vehicle 2 only permits certain changes within a certain time period.

In accordance FIG. 8, the system 1 has at least one first autonomous vehicle 2 and at least one second autonomous vehicle 16, with the system 1 having a coordination control 17, with the coordination control 17 being configured to receive the checked position data of the first autonomous vehicle 2 and to receive the checked position data of the second autonomous vehicle 16 and being configured to calculate a predefined formation of the autonomous vehicles 2, 16 and to transmit calculated trajectory data to the first autonomous vehicle 2 and to the second autonomous vehicle 16.

The use of the position of the first autonomous vehicle 2 relative to the position of an at least second autonomous vehicle 16 is an advantage. A possible collision between the first vehicle 2 and the second vehicle 16 can thus be recognized in the coordination control 17 or in a superior control and can be prevented by corresponding measures, for example a signal to the machine having the collision course, a change of the speed, and/or a change of the steering angle. This application has an advantage with groups of machines or in work processes in which a plurality of machines participate such as on a large construction site or in an agricultural environment in a harvesting process.

### REFERENCE NUMERALS

1 system
2, 16 autonomous vehicle
3 drive
4 brake
5 steering
6 navigation system
7 first radio receiver
8 second radio receiver
9 control and evaluation unit
10, 11 processor units
12 first real time kinematic receiver
13 second real time kinematic receiver
14 inclinometer
15 odometry sensor
17 coordination control
18 communication interface
19 satellite transmitter

1. A system having at least one autonomous vehicle, wherein the autonomous vehicle has at least one drive, at least one brake, and at least one steering;
wherein the vehicle has a navigation system;
wherein the navigation system has a first radio receiver for a global navigation satellite system and a second radio receiver for a global navigation satellite system;
wherein the first radio receiver and the second radio receiver are arranged at a predefined spacing at the vehicle;
wherein the navigation system has a control and evaluation unit to which the first radio receiver and the second radio receiver are connected, wherein the control and evaluation unit has two independent processor units, with the control and evaluation unit being configured to evaluate the position data of the first radio receiver and the position data of the second radio receiver using both processor units and to compare them with one another and with the control and evaluation unit being configured to generate checked position data on a valid agreement of the position data.

2. The system in accordance with claim 1, wherein the navigation system has a first real time kinematic receiver, with the first real time kinematic receiver being connected to the control and evaluation unit, with the control and evaluation unit being configured to evaluate the position data of the first real time kinematic receiver and to correct the position data of the first radio receiver and/or the position data of the second radio receiver.

3. The system in accordance with claim 1, wherein the navigation system has a second real time kinematic receiver, with the second real time kinematic receiver being connected to the control and evaluation unit, with the control and evaluation unit being configured to evaluate the position data of the second real time kinematic receiver and to correct the position data of the first radio receiver and/or the position data of the second radio receiver.

4. The system in accordance with claim 1, wherein the navigation system has at least one three axis inclinometer.

5. The system in accordance with claim 1, wherein the navigation system has at least one odometry sensor.

6. The system in accordance with claim 1 having at least one first autonomous vehicle and at least one second autonomous vehicle, with the system having a coordination control, with the coordination control being configured to receive the checked position data of the first autonomous vehicle and to receive the checked position data of the second autonomous vehicle and being configured to calculate a predefined formation of the autonomous vehicles and to transmit calculated trajectory data to the first autonomous vehicle and to the second autonomous vehicle.

7. A method using a system having at least one autonomous vehicle, wherein the autonomous vehicle has at least one drive, at least one brake, and at least one steering;
wherein the vehicle has a navigation system;
wherein the navigation section has a first radio receiver and a second radio receiver;
wherein the first radio receiver and the second radio receiver are arranged at a predefined spacing on the vehicle;
wherein the navigation system has a control and evaluation unit to which the first radio receiver and the second radio receiver are connected, wherein the control and evaluation unit has two independent processor units, with the control and evaluation unit evaluating the position data of the first radio receiver and the position data of the second radio receiver using both processor units and comparing them with one another and with the control and evaluation unit generating checked position data on a valid agreement of the position data.

8. A method in accordance with claim 7 having at least one first autonomous vehicle and at least one second autonomous vehicle, with the system having a coordination control, with the coordination control receiving the checked position data of the first autonomous vehicle and receiving the checked position data of the second autonomous vehicle and calculating a predefined formation of the autonomous vehicles and transmitting calculated trajectory data to the first autonomous vehicle and to the second autonomous vehicle.
